(19) United States
(12) Patent Application Publication
(10) Pub. No.: US 2015/0304929 A1
(43) Pub. Date: Oct. 22, 2015

(54) USING LINK METRICS AND MOTION STATE FOR EARLY WLAN - WWAN HANDOVER

(71) Applicant: QUALCOMM Incorporated, San Diego, CA (US)

(72) Inventors: Sha Hua, San Diego, CA (US); Jin Won Lee, San Diego, CA (US); Arnaud Meylan, San Diego, CA (US)

(73) Assignee: QUALCOMM Incorporated, San Diego, CA (US)

(21) Appl. No.: 14/258,872

(22) Filed: Apr. 22, 2014

(51) Int. Cl. H04W 36/32

(52) U.S. Cl. CPC H04W 36/32

(57) ABSTRACT

Methods, systems, and devices are described for using information relating to a motion state of a mobile device to inform a handover decision of the mobile device. In one aspect, a method may include obtaining motion state information of the mobile device and, based on the motion state information, generating predictive information, for example relating to whether the mobile device is moving out of a network coverage area, such as a WLAN, to a WWAN or another WLAN. The mobile device may then participate in a handover based on the predictive information. In one aspect, the mobile device may participate in the handover prior to disconnection with a serving network and/or prior to a connection quality with the serving network falling below a connection quality threshold.

### BACKGROUND

The following relates generally to wireless communication, and more specifically to using various metrics to predict that a mobile device is moving out of a network coverage area, for example to inform a handover decision.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Wireless Local Area Networks (WLANs), such as Wi-Fi (IEEE 802.11) networks are widely deployed and used. Wireless Wide Area Networks (WWAN), using mobile telecommunication cellular network technologies such as Long Term Evolution (LTE), Worldwide Interoperability for Microwave Access (WiMAX), Universal Mobile Telecommunication System (UMTS), code-division multiple access (CDMA) 2000, GSM, etc., may operate in conjunction with or adjacent to WLANs. Other examples of such multiple-access systems may include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations or access points (APs), each simultaneously supporting communication for multiple mobile devices or stations (STAs). APs may communicate with STAs on downstream and upstream links Each AP has a coverage range, which may be referred to as the coverage area of the cell. A WLAN, such as a WiFi network, may include multiple APs. In some cases, a mobile device may move through one or more WLANs that are operated by different service providers. In other cases, a mobile device may move from a WLAN to a WWAN or vice versa. In each of these cases, the mobile device may handover to the new network in order to maintain service.

The mobile device may wait until the connection with the serving network is lost or the connection quality degrades significantly before participating in a handover to a new network. This may be in part to reduce costs associated with service from other networks, for example from networks that may be more expensive, such as a WWAN which may generally be more expensive than a WLAN, or another WLAN operated by different service provides, for example outside of a corporate WiFi network in an office building. This delay in handover may result in reduced performance for the user of a mobile device and/or complete loss in service when moving between networks.

### SUMMARY

The described features generally relate to improved systems, methods, and/or apparatuses for using information relating to a motion state of a mobile device to inform a handover decision of the mobile device. In particular, the described techniques may include obtaining motion state information of the mobile device and, based on the motion state information, generating predictive information. The predictive information may relate to whether the mobile device is moving away from at least one AP and/or moving out of a network coverage area, such as a WLAN, to a WWAN or another WLAN. The predictive information may then be used by the mobile device to inform a decision of whether to participate in a handover. In some cases, the mobile device may initiate the handover operation, for example, if the mobile device determines that it is moving out of a serving network. In other cases, a base station or AP currently serving the mobile device may initiate the handover to a target base station or AP. Based on the described techniques, the mobile device may participate in the handover before disconnection and/or the connection quality with the serving network falls below a connection quality threshold.

In some embodiments, the motion state information may include at least one metric, such as information of received signal strength indicator (RSSI), beacon loss rate, sensor information, etc., in relation to a serving AP, at least one other AP, or a combination thereof. The at least one metric may be employed to generate predictive information based on at least one threshold, for example at least one RSSI value, metrics used to determine or estimate a distance between the mobile device and at least one AP in the serving network, etc. The mobile device may obtain measurements of a first metric, e.g., RSSI, when a threshold is satisfied, and/or may obtain measurements of a second metric, e.g., beacon loss rate, when the threshold is satisfied. In other cases, the mobile device may obtain measurements of a first metric when a first threshold is satisfied and may obtain measurements of a second metric when a second threshold is satisfied. The single threshold, and or the first and/or second thresholds may each include an RSSI value, or other metrics indicative of the distance between the mobile device and at least one AP. Generating the predictive information may include predicting a first value of the first metric (e.g., RSSI) at a future time, for example T seconds in the future, predicting a second value of the second metric (e.g., beacon loss rate) at T seconds in the future, and predicting that the mobile device is moving away from a base station if the first value of the first metric exceeds a first threshold, the second value of the second metric exceeds a second threshold, or a combination thereof.

Additionally or alternatively, the motion state information may include information from at least one sensor, such as an accelerometer, a course motion classifier (CMC), etc. In one aspect, the sensor information may be used in conjunction with other motion state information to validate or increase the confidence level of the predictive information. For example, obtaining motion state information may include obtaining measurements of at least one of a first and/or second metric when a threshold is satisfied and obtaining motion state information from at least one sensor. In this scenario, the mobile device may predict that the mobile device is moving away from at least one AP if at least one of the measurements of the first metric or the measurements of the second metric indicate that the mobile device is moving away from the at least one AP, and the motion state information from the at least one sensor indicates that the mobile device is moving away from the at least one AP.

In one aspect, the mobile device, or alternatively the serving AP, may determine whether the target network is associated with the same service provider as the serving network. The service provider information may be used either in combination with or separately from the motion state information to inform the decision of whether to participate in the handover.

In some embodiments, the information relating to the motion state of the mobile device may indicate that the mobile device is moving away from multiple APs of a serving network. In this scenario, generating predictive information based at least in part on the obtained motion state information may include predicting whether the mobile device is moving away from each of the multiple APs of the serving network.

In one aspect, generating the predictive information may include generating a prediction that the mobile device is moving away from a serving network based at least in part on the obtained information relating to a motion state of the mobile device.

In some embodiments, a mobile device may include a motion state information module to obtain information relating to a motion state of the mobile device, a predictive information generator to generate predictive information based at least in part on the obtained motion state information, and a handover module to participate in a handover based at least in part on the generated predictive information. In some cases, the information relating to the motion state of the mobile device may indicate that the mobile device is moving away from at least one AP and/or a serving network. In this scenario, the predictive information generator may be configured to predict whether the mobile device is moving away from at least one of the at least one AP or the serving network. The handover module may be configured to participate in the handover prior to at least one of disconnection with a serving network or a connection quality with the serving network falling below a connection quality threshold.

In one aspect, the motion state information module may be configured to obtain measurements of at least one of a first metric or a second metric when a threshold is satisfied. The measurements of the first metric may include RSSI information and the measurements of the second metric may include beacon loss rate information. In some cases, the predictive information generator may be configured to predict a first value of the first metric at a future time, predict a second value of the second metric at the future time, and predict that the mobile device is moving away from an AP if the predicted value of the first metric exceeds a first threshold, the predicted value of the second metric exceeds a second threshold, or a combination thereof. In yet some cases, the motion state information module may be configured to obtain motion state information of the mobile device from at least one sensor. The predictive information generator may further be configured to predict that the mobile device is moving away from at least one AP if at least one of the measurements of the first metric or the measurements of the second metric indicate that the mobile device is moving away from the at least one AP and the motion state information from the at least one sensor indicates that the mobile device is moving away from the at least one AP.

In some embodiments, such as when the handover is from a serving network associated with a first service provider to a target network, the handover module may be configured to determine whether the target network is associated with the first service provider and participate in the handover based at least in part on the determination.

In some embodiments, an apparatus may include means for obtaining, by a mobile device, information relating to a motion state of the mobile device, means for generating predictive information based at least in part on the obtained motion state information, and means for participating in a handover based at least in part on the generated predictive information. In some cases, the information relating to the motion state of the mobile device may indicate that the mobile device is moving away from at least one of at least one AP or a serving network. The means for generating predictive information may be configured to predict whether the mobile device is moving away from at least one of the at least one AP or the serving network. In yet some cases, the means for obtaining motion state information may include means for obtaining measurements of at least one of a first metric or a second metric when a threshold is satisfied. The measurements of the first metric may include RSSI information and the measurements of the second metric may include beacon loss rate information.

In one aspect, the means for generating predictive information may be configured to predict a first value of the first metric at a future time, predict a second value of the second metric at the future time, and predict that the mobile device is moving away from an AP if the predicted value of the first metric exceeds a first threshold, the predicted value of the second metric exceeds a second threshold, or a combination thereof. In some cases, the means for obtaining motion state information may be configured to obtain motion state information of the mobile device from at least one sensor. The means for generating predictive information may be configured to predict that the mobile device is moving away from at least one AP if at least one of the measurements of the first metric or the measurements of the second metric indicate that the mobile device is moving away from the at least one AP, and the motion state information from the at least one sensor indicates that the mobile device is moving away from the at least one AP.

In some cases, for example when the handover is from a serving network associated with a first service provider to a target network, the means for participating in the handover may be configured to determine whether the target network is associated with the first service provider and participate in the handover based at least in part on the determination.

In some embodiments, a computer program product, operable on a mobile device, may include a non-transitory computer-readable medium storing instructions executable by a processor. The instructions may enable the processor to obtain information relating to a motion state of the mobile device, generate predictive information based at least in part on the obtained motion state information, and participate in a handover based at least in part on the generated predictive information.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2 shows a block diagram of an exemplary wireless communication system including a Station (STA) and multiple Access Points (APs), in accordance with various embodiments;

FIG. 3 shows a block diagram illustrating a device for using information relating to a motion state of a mobile device to inform a handover decision of the mobile device, in accordance with various embodiments;

FIG. 4 shows a block diagram illustrating one embodiment of a motion station information module and a predictive information generator for informing a handover decision of a mobile device, in accordance with various embodiments;

FIG. 5 shows a block diagram of a device configured for using information relating to a motion state of a mobile device to inform a handover decision of the mobile device, in accordance with various embodiments;

FIG. 6 illustrates a graph showing an exemplary relationship between signal strength and distance from an AP, in accordance with various embodiments;

FIG. 7 illustrates a graph showing an exemplary relationship between beacon received rate and distance from an AP, in accordance with various embodiments;

FIG. 8 illustrates a graph showing an exemplary first order prediction of the relationship between signal strength and distance from an AP, in accordance with various embodiments;

FIG. 9 illustrates exemplary handovers of a mobile device in relation to a movement direction of the mobile device and channel regions of a serving AP, in accordance with various embodiments; and

FIGS. 10-12 illustrate flowcharts of methods for using information relating to a motion state of a mobile device to inform a handover decision of the mobile device.

### DETAILED DESCRIPTION

The described features generally relate to improved systems, methods, and/or apparatuses for using information relating to a motion state of a mobile device to inform a handover decision of the mobile device. In particular, the described techniques may include obtaining motion state information of the mobile device and, based on the motion state information, generating predictive information, for example relating to whether the mobile device is moving out of a network coverage area, such as a WLAN, toward a target network, such as a WWAN or another WLAN. The predictive information may then be used by the mobile device to inform a decision of whether to participate in a handover to the target network.

In one aspect, RSSI, or statistics of RSSI, may be used to predict if a mobile device is moving away from a serving AP and/or serving network, for example when a first threshold (e.g., distance from the AP) is satisfied. When the mobile device is close to an AP, RSSI may be particularly informative of movement of the mobile device, such that the signal strength received by the mobile device may be approximately linear. Based on this relationship, RSSI, or statistics of RSSI, can be used to generate predictive information indicative of whether the mobile device is moving away from the AP and/or the serving network, for example to initiate an early handover decision.

In another aspect, a beacon loss rate may be used to predict if a mobile device is moving away from a serving AP and/or serving network, for example when a second threshold (e.g., a second distance from the AP) is satisfied. The AP may send a delivery traffic indication message (DTIM) beacon to the mobile device periodically to indicate if the AP has data to send to the mobile device and to synchronize the communication link with the mobile device. The beacon loss rate may be determined based at least in part on the receive rate of the DTIM beacon. The value of the determined beacon loss rate may be proportionate (in some cases approximately linear) to the distance the mobile device is from the AP. Based on this relationship, beacon loss rate, or statistics of the beacon loss rate, can be used generate predictive information indicative of whether the mobile device is moving away from the AP and hence away from the serving network, to inform an early handover decision.

In another aspect, using both RSSI, such as when a first threshold is satisfied, and beacon loss rate, such as when the first threshold or alternatively a second threshold is satisfied, may improve the accuracy of the movement prediction of the mobile device. For example, RSSI may be used to generate predictive information of the motion state of the mobile device when the mobile device is closer to the AP (e.g., based on a higher RSSI value) and beacon loss rate may be used when the mobile device moves farther away from the AP (e.g., based on a lower RSSI value). In this way, early handover may be triggered with more accuracy to improve performance of communications with the mobile device, while minimizing unnecessary cost associated with more expensive networks, such as WWANs or WLANs associated with a different service provider or enterprise.

The motion state of the mobile device may also include information from at least one sensor, such as an accelerometer or a course motion classifier, of the mobile device. The sensor information may be used in conjunction with RSSI and/or the beacon loss rate to improve the confidence level or accuracy of the movement prediction of the mobile device.

Alternatively, or additionally, information of the serving network and nearby networks, such as service providers of each, may be used to inform the handover decision. If the mobile device is moving inside a corporate or enterprise WLAN, such as in an office building, it may be efficient and more cost efficient to roam between WLAN APs, without handing over to a new network. If the mobile device is moving out of the corporate WLAN, or to a network not associated with any corporate WLAN, it may improve communication performance of the mobile device to switch from the serving WLAN to a WWAN or other non-corporate WLAN, for example prior to the disconnection with the serving network

The following description provides examples and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments. For the purposes of explanation, the described methods, systems, and devices refer specifically to at least one WLAN; however, other radio communication or access technologies may be compatible with and implemented using the described techniques.

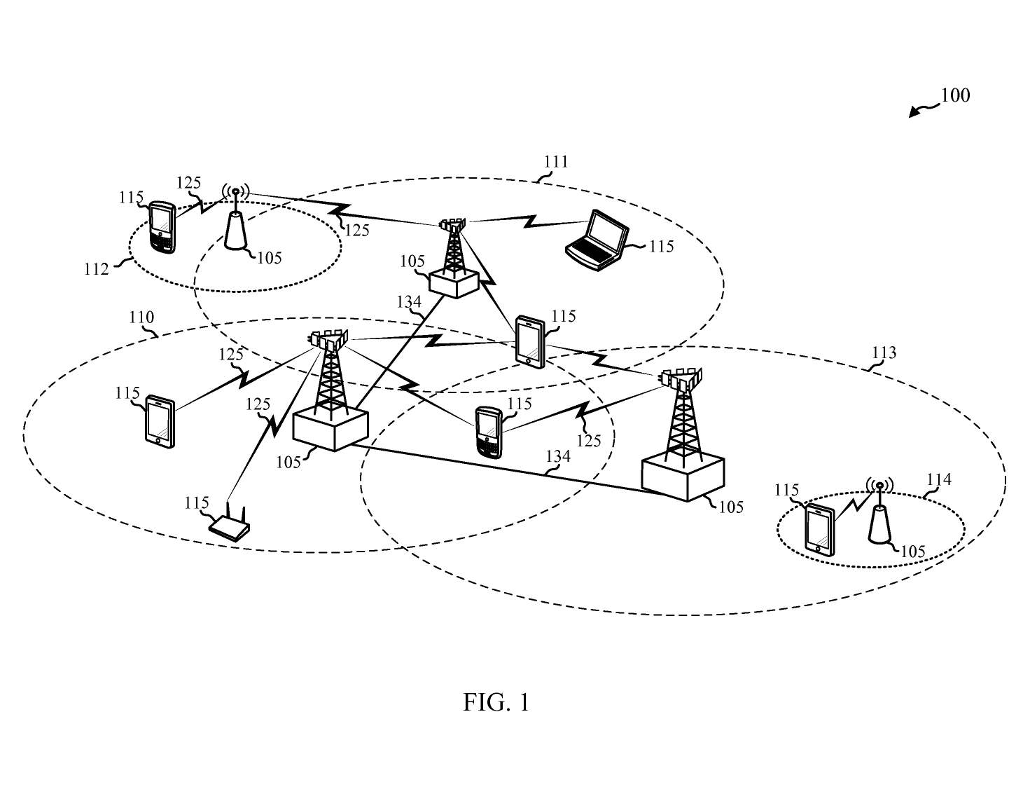

Referring first to FIG. 1, a block diagram illustrates a wireless communications system 100 including multiple networks represented by coverage areas 110-114, which may include at least one WLAN or WiFi network with coverage areas 110, 113, 114 such as, e.g., a network implementing at least one of the IEEE 802.11 family of standards. The wireless communications system 100 may also include at least one Wireless Wide Area Network (WWAN) with coverage areas 111, 112 implementing LTE, WiMAX, or any other mobile telecommunication cellular network technology. The networks or network coverage areas 110-114 may include at least one base station or access point (AP) 105 and at least one wireless device 115, such as mobile devices, personal digital assistants (PDAs), other handheld devices, netbooks, notebook computers, tablet computers, laptops, display devices (e.g., TVs, computer monitors, etc.), printers, etc. While only one AP 105 is illustrated in each of network coverage areas 110-114, each network coverage area 110-114 may include multiple base stations or APs 105. Each of the wireless devices 115, also referred to as wireless stations, stations (STAs), mobile devices (MSs), mobile devices, access terminals (ATs), user equipments (UEs), subscriber stations (SSs), or subscriber units may associate and communicate with an AP 105 via a communication link 125. Each AP 105 has a coverage area, which in FIG. 1 may be synonymous with a network (a network, however may include multiple APs 105) such that stations 115 within that area can typically communicate with the AP 105. The devices 115 may be dispersed throughout the coverage area. Each device 115 may be stationary or mobile.

A core network (not shown) may communicate with the base stations 105 of a WWAN implementing LTE via a backhaul link (not shown) (e.g., an S1 interface, etc.). The base stations 105 may also communicate with one another, e.g., directly or indirectly via backhaul links 134 (e.g., an X2 interface, etc.) and/or through a core network. The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

A mobile device 115 can be covered by more than one AP 105 and can therefore associate with at least one AP 105 at different times. A single AP 105 and an associated set of stations may be referred to as a basic service set (BSS). An extended service set (ESS) is a set of connected BSSs. A distribution system (DS) (not shown) is used to connect APs in an extended service set. A coverage area for an access point 105 may be divided into sectors making up only a portion of the coverage area (not shown). The system 100 may include access points 105 of different types (e.g., metropolitan area, home network, etc.), with varying sizes of coverage areas and overlapping coverage areas for different technologies. Although not shown, other wireless devices can communicate with the AP 105.

While the devices 115 may communicate with each other through the AP 105 using communication links 125, each device 115 may also communicate directly with at least one other device 115 via direct wireless links (not shown). The devices 115 and APs 105 in these examples may communicate according to the WLAN radio and baseband protocols including by implementing the physical (PHY) and medium access control (MAC) layers from IEEE 802.11, and its various versions.

In certain examples, the base stations or APs 105 may communicate, either directly or indirectly, with each other over backhaul links 134, which may be wired or wireless communication links. At least one of network or wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

The base stations or APs 105 may wirelessly communicate with the mobile devices 115 via at least one base station antenna. Each of the base stations 105 sites may provide communication coverage for a respective coverage area 110-114. In some examples, base stations 105 may also be referred to as a base transceiver station, a radio base station, an access point, a radio transceiver, a basic service set (BSS), an extended service set (ESS), a NodeB, eNodeB, Home NodeB, a Home eNodeB, or some other suitable terminology, particularly with respect to WWANs. The coverage area 110-114 for a base station may be divided into sectors making up only a portion of the coverage area (not shown). The wireless communications system 100 may include base stations 105 of different types (e.g., macro, micro, and/or pico base stations). There may be overlapping coverage areas for different technologies.

In certain examples, networks within the wireless communications system 100 may be examples of LTE/LTE-A network communication systems. In LTE/LTE-A network communication systems, the terms evolved Node B (eNodeB) may be generally used to describe the base stations 105. The wireless communications system 100 may be a Heterogeneous LTE/LTE-A network in which different types of eNodeBs provide coverage for various geographical regions. For example, each base station 105 may provide communication coverage for a macro cell, a pico cell, a femto cell, and/or other types of cell. A macro cell generally covers a relatively large coverage area (e.g., several kilometers in radius) and may allow unrestricted access by mobile devices 115 with service subscriptions with the network provider. A pico cell would generally cover a relatively smaller coverage area (e.g., buildings) and may allow unrestricted access by mobile devices 115 with service subscriptions with the network provider. A femto cell would also generally cover a relatively small coverage area (e.g., a home) and, in addition to unrestricted access, may also provide restricted access by mobile devices 115 having an association with the femto cell (e.g., mobile devices 115 in a closed subscriber group (CSG), mobile devices 115 for users in the home, and the like). A base station 105 for a macro cell may be referred to as a macro eNodeB. A base station 105 for a pico cell may be referred to as a pico eNodeB. And, a base station 105 for a femto cell may be referred to as a femto eNodeB or a home eNodeB. A base station 105 may support one or multiple (e.g., two, three, four, and the like) cells.

The communication links 125 shown in the wireless communications system 100 may include uplink (UL) transmissions from a mobile device 115 to a base station 105, and/or downlink (DL) transmissions, from a base station 105 to a mobile device 115. The downlink transmissions may also be called forward link transmissions while the uplink transmissions may also be called reverse link transmissions.

In some embodiments, a mobile device 115 may move from a coverage area of one network to a coverage area of another network. In some cases the two networks may both be WLANs, and in other cases the mobile device 115 may move from a WLAN to a WWAN, or vice versa. In order to improve communication performance of the mobile device 115 when moving between networks, it may be beneficial to inform a handover decision of the mobile device 115 with motion state information of and obtained by the mobile device 115. The mobile device 115 may generate predictive information, for example of whether the mobile device 115 is moving from one network (e.g., 110) to another network (e.g., 111) based on the motion state information. In this way, the mobile device 115 may participate in and/or trigger a handover to a target network prior to disconnection with the serving network and/or a meaningful degradation in channel quality with the serving network.

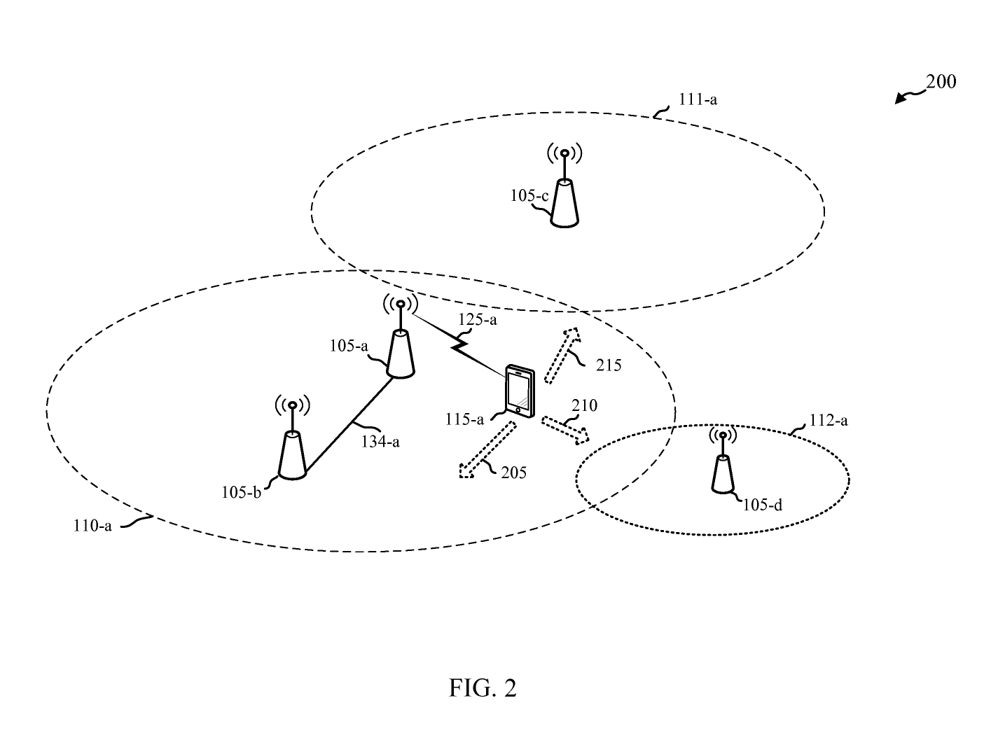

Referring next to FIG. 2, a block diagram illustrates a wireless communications system 200 including a mobile device 115-a moving between three networks with coverage areas 110-a, 111-a, and 112-a. Each network coverage area 110-a, 111-a, and 112-a may include at least one AP or base stations 105-a and 105-b, 105-c, and 105-d. The mobile device 115-a, network coverage areas 110-a, 111-a, and/or 112-a, and/or the APs 105-a, 105-b, 105-c, and/or 105-d may be examples of mobile devices 115, network coverage areas 110, 111, 112, 113 and/or 114, and/or APs 105 described in reference to FIG. 1. Network coverage area 110-a may represent a first WLAN, network coverage area 112-a may represent a second WLAN, and network coverage area 111-a may represent a WWAN. It should be appreciated that wireless communications system 200 is given only as an example; other network arrangements are contemplated herein.

As shown, mobile device 115-a may be in communication with a serving AP 105-a via communication link 125-a. The AP 105-a may be part of a WLAN having a coverage area 110-a. The WLAN having a coverage area 110-a may also include a second AP 105-b, which may be in communications via backhaul link 134-a with AP 105-a. In other implementations, base stations 105-a and 105-b may be part of another communications network, for example implementing a WWAN technology.

The mobile device 115-a may be located near the periphery of network coverage area 110-a and may be moving, for example, in any of directions 205, 210, or 215. The mobile device 115-a may obtain at least one metric related to the motion state of the mobile device 115-a, as will be described in greater detail below. Based on the motion state information, the mobile device 115-a may generate predictive information, for example relating to whether the mobile device is moving out of network coverage area 110-a. The mobile device 115-a may then participate in a handover, for example to AP 105-b, 105-c, or 105-d of network coverage areas 111-a, 112-a, or 110-a based on the generated predictive information.

Specifically, the mobile device 115-a may obtain motion state information indicating that the mobile device 115-a is moving away from serving AP 105-a, such as in directions 210, 215, or another direction away from AP 105-a. In other embodiments, the motion state information may indicate that the mobile device 115-a is moving away from serving AP 105-a and another serving network AP 105-b, such as in directions 210, 215, or any other direction away from both APs 105-a and 105-b. Based on the motion state information, the mobile device 115-a may generate predictive information indicating that the mobile device 115-a is moving away from each of serving network APs 105-a, 105-b, and hence from the serving network coverage area 110-a. This predictive information may be used by the mobile device 115-a to participate in a handover to AP 105-c of network coverage area 111-a, for example if the mobile device 115-a predicts that it is moving in direction 215 or another direction towards network coverage area 111-a. Similarly, if the predictive information indicates that the mobile device 115-a is moving in direction 210, or any other direction towards network coverage area 112-a, the mobile device may participate in a handover to AP 105-d based on the predictive information.

In one aspect, by using predictive information to participate in a handover to a different network, such as networks represented by coverage areas 111-a and 112-a, the mobile device 115-a may handover before disconnection with the serving network (e.g., APs 105-a and/or 105-b) occurs, and/or before the connection quality with the serving network (e.g., communication link 125-a), degrades below a connection quality threshold. The connection quality threshold may include a data rate, a latency value, a throughput requirement of at least one application of the mobile device 115-a, etc.

In one aspect, the motion state information may indicate that the mobile device 115-a is moving away from serving AP 105-a, such as in direction 205 or other similar direction. The motion state information may also indicate that the mobile device 115-a is moving toward another serving network AP 105-b. The mobile device 115-a, based on this example of motion state information, may generate predictive information indicating that the mobile device 115-a is not leaving the serving network represented by coverage area 110-a. In this scenario, the mobile device 115-a may participate in a handover to AP 105-b based on the predictive information. In some cases, the mobile device 115-a may trigger the handover at a time slightly before established handover procedures. However, in some cases, the mobile device 115-a may not initiate the handover prior to the established handover procedures if the predictive information indicates that the mobile device is moving away from the serving network (e.g., all APs 105 in the serving network coverage area). This may be because intra-network handovers generally do not suffer from degradation in connection quality to an extent that inter-network handovers suffer, and therefore do not present as negative of an experience to the end user. In other cases, the mobile device 115-a may participate in a handover to AP 105-b according to normal handover procedures.

In yet another aspect, the motion state information may indicate that the mobile device 115-a is moving towards the serving AP 105-a or maintaining a relative distance from the AP 105-a (for example moving in a circle around AP 105-a). In this scenario, the mobile device 115-a may generate predictive information that indicates the mobile device 115-a is not moving towards another network, such as network coverage areas 111-a or 112-a. In some cases, this may be represented by movement direction 205. The mobile device 115-a may use the predictive information to delay a handover to another network, for example to AP 105-c of network coverage area 111-a or AP 105-d of network coverage area 112-a, until the motion state information and/or the predictive information indicate that the mobile device 115-a is moving away from the serving network represented by coverage area 110-a and toward coverage areas 111-a or 112-a.

In some embodiments, the motion state information may include at least one metric, such as RSSI, beacon loss rate information, sensor information, etc. In some aspects, the mobile device 115-a may obtain measurements of at least one of a first metric or a second metric when a threshold is satisfied. The first metric may include RSSI and the second metric may include beacon loss rate information. The threshold may be any RSSI value that is indicative of degradation in signal quality, serving cell coverage area size, or other characteristics of the serving and/or other networks.

In some embodiments, the mobile device 115-a may monitor/obtain first and/or second metric information or measurements continuously. The mobile device 115-a may generate predictive information based on the first and/or second metric information obtained at a previous time or during a previous time period. In some cases, where the first and second metrics used are RSSI and beacon loss rate, continuously monitoring the RSSI and beacon loss rate may consume no additional power.

In some aspects, the mobile device 115-a may obtain measurements of a first metric when a first threshold is satisfied, and/or may obtain measurements of a second metric when a second threshold is satisfied. The first metric may include RSSI and the second metric may include beacon loss rate information. In some cases, at least one of the first and second thresholds may be RSSI values, or based on distances the mobile device 115-a is from an AP 105, such as APs 105-a and/or 105-b, for example. In other cases, the first and/or second thresholds (which in some cases may be the same) may be based on other metrics, such as motion state information, e.g., whether the mobile device 115-a is in motion or at rest, whether the mobile device 115-a changes direction of motion, etc. In one scenario, the mobile device 115-a may obtain measurements of the first and second metrics when at least one sensor of the mobile device 115-a indicate that the mobile device 115-a has gone from a rest state to a motion state. In some cases, distance between the mobile device 115-a and the AP 105-a, 105-b may be determined or estimated based on RSSI information, or other information.

In one aspect, the motion state information may include information received from at least one sensor of the mobile device 115-a, such as an accelerometer, a course motion classifier or any other similar sensor. Information from at least one sensor may include movement information of the mobile device 115-a, acceleration information, direction of movement information, etc. The sensor information may be used in addition to other motion station information, e.g., RSSI, beacon loss rate information, etc., by the mobile device 115-a to generate predictive information. In one aspect, the sensor information may improve the accuracy and/or confidence level of the movement prediction made by the mobile device 115-a.

Alternatively, or additionally, information of the serving network 110-a and nearby networks 111-a and/or 112-a such as service providers of each, may be used to better inform the handover decision. If the mobile device 115-a is moving inside a corporate or enterprise WLAN, such as in an office building, it may be better and more cost effective to roam between WLAN APs, such as AP 105-a and 105-b. If the mobile device 115-a is moving out of the corporate WLAN 110-a, for example to a WWAN not associated with any corporate WLAN, for example network 111-a, or to another WLAN 112-a, it may be better and improve communication performance of the mobile device 115-a to switch from the serving WLAN 110-a to a WWAN 111-a or other non-corporate WLAN 112-a. From the most recent scan results, the mobile device 115-a can check if any APs 105 have the same Service Set Identifier (SSID) but different Basic Service Set Identifier (BSSID) as the current serving AP 105-a. If the answer to that inquiry is yes, then the mobile device 115-a may decide not to trigger a handover. This may be the case, for example, when the mobile device scans AP 105-b, as it is in the same network as AP 105-a. In another implementation, the mobile device 115-a can monitor the first and second order statistics of the APs 105 that have the same SSID but different BSSID as the current serving AP 105-a, such as AP 105-b. The mobile device 115-a can then infer if it is moving towards another enterprise AP 105-c, 105-d. If the inference indicates that the mobile device 115-a is moving away from all such enterprise APs 105, then an early handover may be triggered. If the mobile device 115-a infers that it is not moving away from all enterprise APs 105, the mobile device 115-a may refrain from participating in an early handover and/or delay handover.

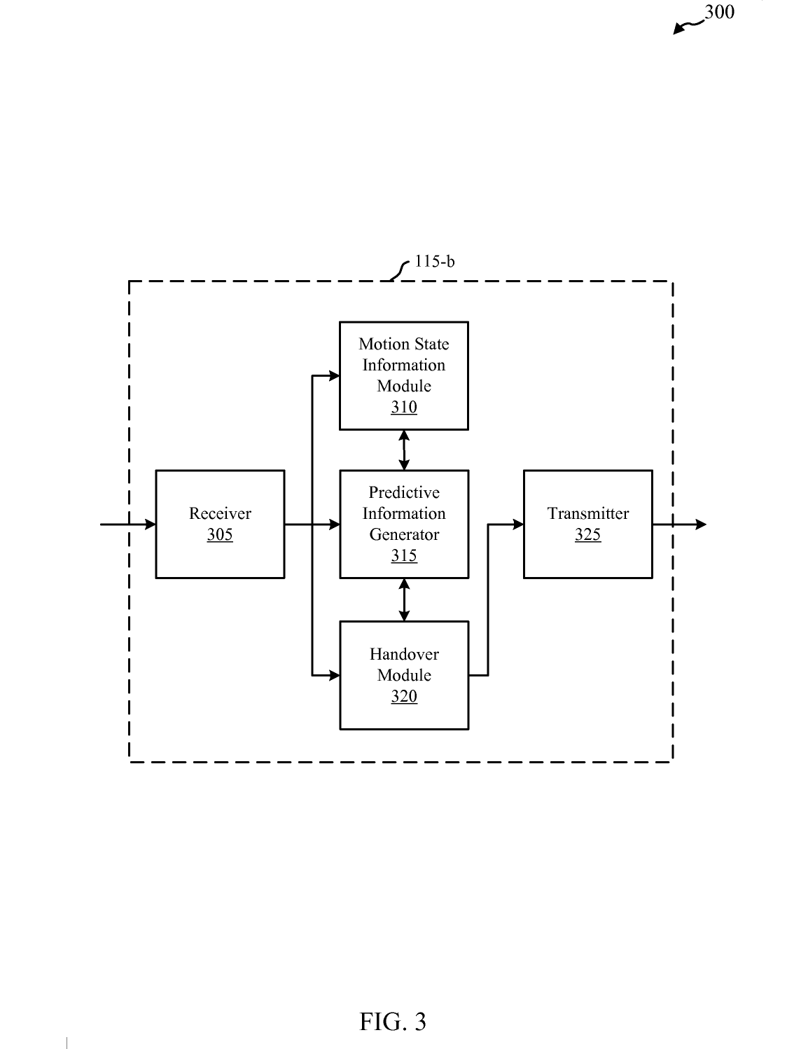

FIG. 3 shows a block diagram 300 of a mobile device 115-b configured for using information relating to a motion state of the mobile device 115-b to generate predictive information to be used for participating in a handover, in accordance with various embodiments described herein. The mobile device 115-b may be an example of at least one aspect of the mobile device 115 described above with reference to FIGS. 1 and/or 2. The mobile device 115-b may communicate with at least one base station or AP 105 via communication link 125, and move between different coverage areas 110-114 of different networks as described above in reference to FIGS. 1 and/or 2. The mobile device 115-b may include a receiver 305, a motion state information module 310, a predictive information generator 315, a handover module 320, and/or a transmitter 325. Each of these components may be in communication with each other.

The components of the mobile device 115-b may, individually or collectively, be implemented using at least one application-specific integrated circuit (ASICs) adapted to perform some or all of the applicable functions in hardware. Alternatively, the functions may be performed by at least one other processing unit (or core), on at least one integrated circuit. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by at least one general or application-specific processor.

The receiver 305 may receive information such as packet, data, and/or signaling information regarding what the mobile device 115-b has received or transmitted. The received information may be utilized by the mobile device 115-b for a variety of purposes. In some cases, the receiver 305 may be configured to receive data or transmissions, for example from at least one AP or base station 105, to further enable the various techniques described above for using motion state information to inform a handover decision of the mobile device 115-b.

The transmitter 325 may transmit information such as packet, data, and/or signaling information from the mobile device 115-b. In some cases, the transmitter 325 may be configured to transmit data to at least one AP or base stations 105.

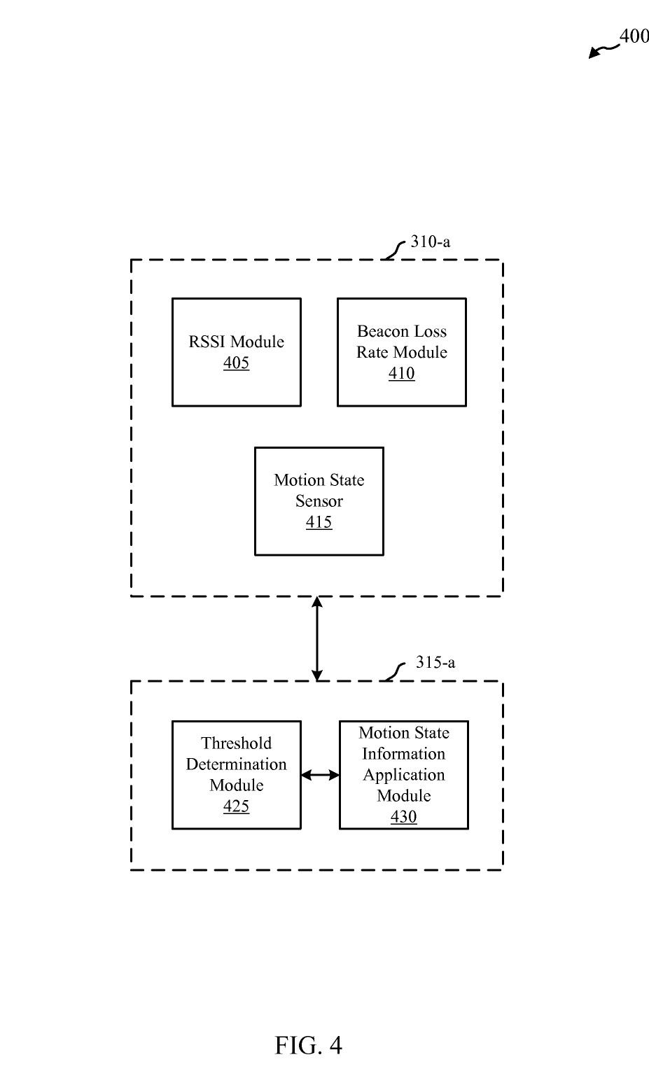

The receiver 305 may receive at least one communication from a serving AP 105, such as data requested by the mobile device 115-b for example, by at least one application running on the mobile device 115-b. The receiver 305 may communicate information related to the received communication(s) and/or the received communications(s) themselves to the motion state information module 310. The motion state information module 310 may determine RSSI information and/or beacon loss rate information from the received communication(s). The techniques for determining RSSI and beacon loss rate information from at least one received communication will be described in greater detail below in reference to FIGS. 4 and 6-8. In some embodiments, the motion state information module 310 may also receive information from at least one sensor (not shown).

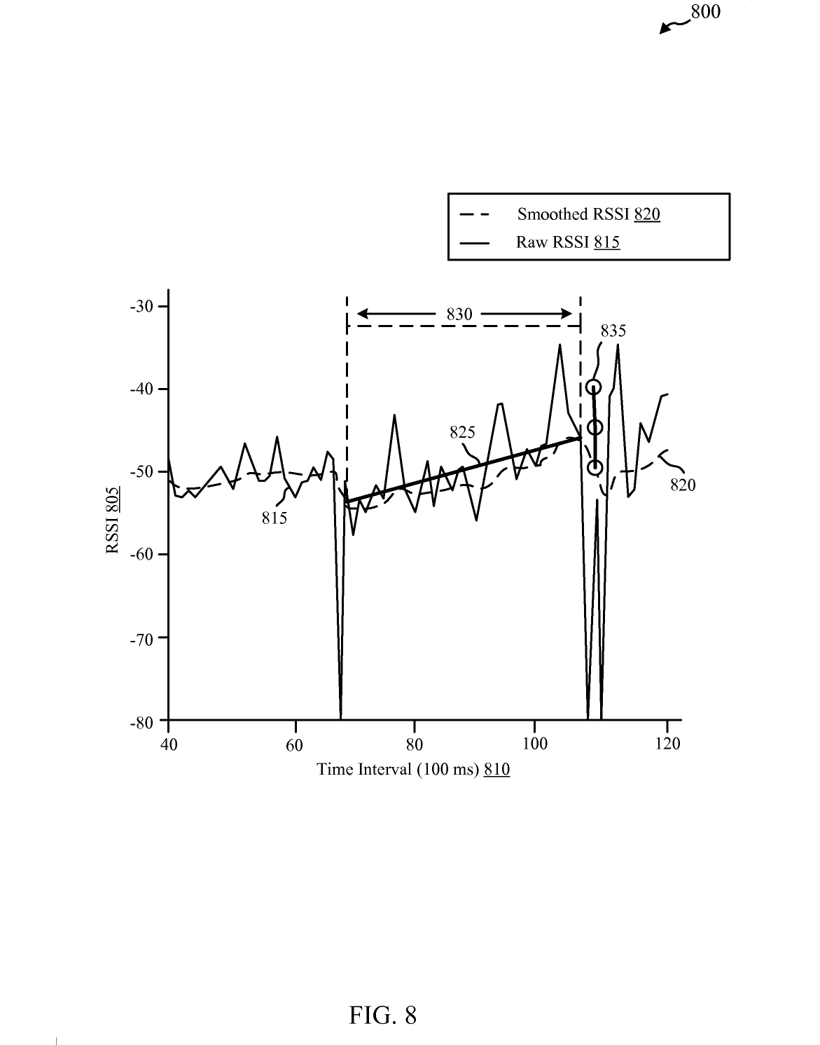

The motion state information module 310 may communicate the determined or estimated motion state information to the predictive information generator 315. The predictive information generator 315 may use the motion state information to predict, for example, if the mobile device 115-b is moving away from a serving network and/or towards a target network. In some embodiments, the predictive information generator 315 may predict at least one metric, such as RSSI, beacon loss rate, etc., at a future time, for example T seconds in the future, and use the predicted metric values to infer that the mobile device 115-b is moving away from a serving network and/or towards a target network. These techniques and others will be described in greater detail with reference to FIGS. 4 and 8 below.

The predictive information generator 315 may then communicate the predicted information to the handover module 320. The handover module 320 may use the predicted information to influence a decision to participate in a handover, for example with a nearby AP 105 of a different network, such as another WLAN or a WWAN. In some cases, the handover module 320 may also receive information, for example via receiver 305, indicative of whether a nearby AP 105, such as a target AP 105, is associated with a service provider of the serving network. In some cases, if a nearby AP 105 is not associated with a service provider of the serving network, which may be a WLAN, it may be beneficial to trigger an early handover to the target network, such as a WWAN or another WLAN. In other cases, for example if a target AP 105 has the same SSID but different BSSID as the serving AP 105, it may be beneficial to delay (e.g., not trigger) handover to the target AP 105. In some embodiments, the handover module 320 may request service provider information via the transmitter 325 and receive the information via the receiver 305.

The handover module 320, after making a decision whether to perform or participate in a handover, may effectuate the handover via communicating a command to the transmitter 325 and/or receiving necessary handover information via receiver 305.

FIG. 4 shows a block diagram 400 illustrating one embodiment of a motion state information module 310-a in communication with a predictive information generator 315-a, in accordance with various embodiments. The motion state information module 310-a and the predictive information generator 315-a may be an example of the motion state information module 310 and the predictive information generator 315 of FIG. 3. The motion state information module 310-a may include a RSSI module 405, a beacon loss rate module 410, and a motion state sensor module 415. The predictive information generator 315-a may include a threshold determination module 425 in communication with a motion state information application module 430.

The RSSI module 405 may determine RSSI information from at least one received communication from an AP 105, such as a serving AP 105-a or an in-network AP 105-b described above in reference to FIG. 2. This may include measuring the signal strength of the at least one received communication, via techniques well known in the art. The RSSI module 405 may communicate current RSSI and/or historic RSSI to the threshold determination module 425 and/or to the motion state information application module 430 of the predictive information generator 315-a to be used for generating predictive information of the mobile device 115-b.

In one aspect, RSSI may be particularly informative of movement of the mobile device 115-b, when the mobile device 115-b is close to an AP 105-a, 105-b, such as from 0 to approximately 40 meters. A first threshold, which may be determined by the threshold determination module 425, may include any distance within the range from 0-40 meters or any other similar or applicable value. In some embodiments, the first threshold may include a RSSI value, for example determined and/or obtained by the RSSI module 405, indicative of a distance between an AP 105-a, 105-b and the mobile device 115-b of 0 to 40 meters. Within this range of 0 to 40 meters, the signal strength received by the mobile device 115-b may be approximately linear. Based on this relationship, RSSI, or statistics of RSSI can be used, for example by the motion state information application module 430, to infer if the mobile device 115-b is moving away from the AP 105-a, 105-b, to ultimately influence a handover decision.

The RSSI module 405 may also use the determined RSSI values to estimate a distance between the mobile device 115-b and an AP 105, such as a serving AP 105-a and/or another in-network AP 105-b as described above in reference to FIG. 2. The RSSI module 405 may correlate the current RSSI value with historic RSSI values, with a table of previously recorded RSSI values, etc., via techniques well known in the art, to determine a current distance between the mobile device 115-b and an AP 105. This distance may be communicated to the motion state information application module 430, to be used for determining if the current RSSI should be used to predict movement of the device 115-b (e.g., satisfies a first distance threshold). In other implementations, the RSSI module 405 may communicate the current measured RSSI to the motion state information application module 430, where the motion state information application module 430 may determine a distance value based on the measured RSSI.

The threshold determination module 425 may use the current RSSI and/or the historic RSSI to set at least one threshold for applying different metrics (e.g., RSSI and beacon loss rate) to be used for generating movement prediction information. Specifically, the threshold determination module 425 may set at least one threshold (e.g., distance thresholds based on RSSI) for using different metrics to predict movement information of the mobile device 115-b. In some cases, the threshold determination module 425 may set at least one threshold based on previously stored threshold information, for example stored in a local memory of device 115-b or accessed via a serving AP 105. In some cases different thresholds for using different motion station information for generating predictive movement information of the device 115-b may be based on other measured or know metrics, values, etc., besides RSSI and/or a distance between the mobile device 115-b and an AP 105.

The threshold determination module 425 may communicate at least one threshold to the motion state information application module 430. The motion state information application module 430 may then compare the received current RSSI value and at least one threshold to generate predictive movement information of the mobile device 115-b. In one example, the RSSI threshold may be satisfied if the mobile device 115-b is determined to be within a certain distance of the AP 105. If the RSSI threshold is satisfied, the motion state information application module 430 may generate predictive information of the RSSI at a time T seconds in the future, which may indicate whether the mobile device 115-b is moving away from a serving AP 105-a and/or serving network 110-a. For example, a decrease in the RSSI may indicate that the mobile device 115-a is moving away from the serving AP 105-a and/or the serving network 110-a, whereas an increase in RSSI may indicate that the mobile device 115-b is moving toward a serving AP 105. The predicted value may then be used to inform the decision to handover by the mobile device 115-b, for example via communicating the predictive information to the handover module 320 of FIG. 3.

Similarly, the beacon loss rate module 410 may determine a beacon loss rate from at least one received communication from an AP 105, such as a serving AP 105-a or an in-network AP 105-b described above in reference to FIG. 2. The AP 105-a, 105-b may send a delivery traffic indication message (DTIM) beacon to the mobile device 115-b periodically, for example every 100 ms, to indicate if the AP 105-a, 105-b has data to send to the mobile device 115-b and to synchronize the communication link. The beacon loss rate module 410 may determine the beacon receive rate by dividing the number of received beacons during a time window W by the quantity (W/100). The beacon loss rate module 410 may determine the beacon loss rate by subtracting the beacon receive rate from W/100. The value of the determined beacon loss rate may be proportionate (in some cases approximately linear) to the distance the mobile device 115-b is from the AP 105-a, 105-b, such as when the mobile device 115-b is within a range of approximately 10 to 70 meters from the AP 105-a, 105-b. The beacon loss rate module 410 may communicate the current beacon loss rate information and/or historic beacon loss rate information to the threshold determination module 425 and/or to the motion state information application module 430 of the predictive information generator 315-a to be used for generating predictive information.

The threshold determination module 425 may then determine a threshold for which to apply to the beacon loss rate information. The beacon loss rate information threshold may be determined based on the current and/or historic beacon loss rate information, and/or based on previously stored threshold information, for example stored in a local memory of mobile device 115-b or accessed via a serving AP 105. In other cases, the beacon loss rate threshold may be determined based on RSSI and/or distance information of a distance between the mobile device 115-b and an AP 105. For example, the beacon loss rate threshold may, for example, include any distance (or RSSI corresponding to a distance) within the range from 10 to 70 meters or any other similar or applicable value.

The threshold determination module 425 may communicate at least one threshold to the motion state information application module 430. The motion state information application module 430 may then compare the received current beacon loss rate information and at least one beacon loss rate threshold to generate predictive movement information of the mobile device 115-b. In one example, the beacon loss rate threshold may be satisfied if the mobile device 115-b is determined to be within a certain distance of the AP 105, including at least a minimum distance away from the AP 105. If the beacon loss rate threshold is satisfied, the motion state information application module 430 may generate predictive information of the beacon loss rate information at a time T seconds in the future, which may indicate whether the mobile device 115-b is moving away from a serving AP 105-a and/or serving network 110-a. For example an increase in the beacon loss rate information may indicate that the mobile device 115-b is moving away from the serving AP 105-a and/or the serving network 110-a. This predicted value may then be used to inform the decision to handover by the mobile device 115-a. The predicted value may then be used to inform the decision to handover by the mobile device 115-b, for example via communicating the predictive information to the handover module 320 of FIG. 3.

In another aspect, using both RSSI, such as when the mobile device 115-b is closer to the AP 105-a, 105-b (e.g., 0-40 meters), and beacon loss rate, such as when the mobile device 115-b moves farther away from the AP 105-a, 105-b (e.g., 10-70 meters), may improve the accuracy of the movement prediction of the mobile device 115-b. Thus, if the predicted RSSI of T seconds later is less than an RSSI threshold or the predicted beacon rate of T seconds later is less than a beacon threshold, early switching between serving network 110-a and another network 111-a, 112-a may be triggered. In this way, early handover may be triggered with more accuracy to improve performance of communications with the mobile device 115-b.

In some embodiments, the motion state sensor module 415 may include at least one of an accelerometer, course motion classifier, etc., and may collect sensor information related to a motion state of the mobile device 115-b. The sensor information may include a speed and/or direction at which the mobile device 115-b is currently traveling, an acceleration of the mobile device 115-b, or any other movement information. The motion state sensor module 415 may communicate the sensor information to the motion state information application module 430.

The motion state information application module 430 may use the sensor information in conjunction with other motion state information (e.g., RSSI received from the RSSI module 405 and/or beacon loss rate information received from the beacon loss rate module 410), to improve the accuracy and/or confidence level of generated predictive information. For example, the motion state information application module 430 may combine various motion state information to generate predictive information, for example by determining if the predicted RSSI of T seconds later is less than an RSSI threshold or the predicted beacon rate of T seconds later is less than a beacon threshold, and at least one motion sensor indicates that mobile device 115-b is currently moving. In this way, more accurate predictive information may be generated by the predictive information generator 315-a, to better inform the handover module 320 of FIG. 3 to participate in handover.

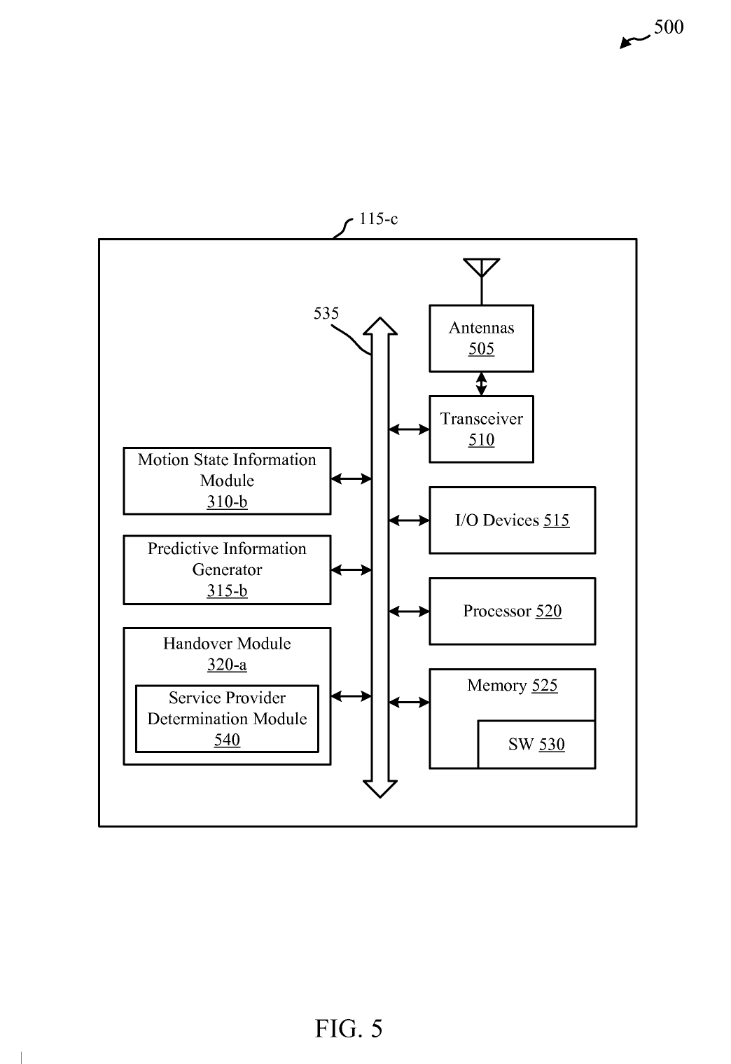

FIG. 5 is a block diagram 500 of a mobile device 115-c configured for using information relating to a motion state of the mobile device 115-c to generate predictive information to be used for participating in a handover, in accordance with various embodiments described herein. The mobile device 115-c may be an example of at least one aspect of the mobile device 115 described above with reference to FIGS. 1, 2, and/or 3 and/or may implement at least one aspect of the motion state information module 310-a and/or the predictive information generator 315-a described above with reference to FIG. 4. The mobile device 115-c may communicate with at least one base station or AP 105 via communication link 125, and move between different coverage areas 110-114 of different networks as described above in reference to FIGS. 1 and/or 2. The mobile device 115-c may have any of various configurations, such as personal computers (e.g., laptop computers, netbook computers, tablet computers, etc.), smartphones, cellular telephones, PDAs, wearable computing devices, digital video recorders (DVRs), internet appliances, routers, gaming consoles, e-readers, display devices, printers, etc. The mobile device 115-c may have an internal power supply (not shown), such as a small battery, to facilitate mobile operation.

The components of the mobile device 115-c may, individually or collectively, be implemented using at least one application-specific integrated circuit (ASIC) adapted to perform some or all of the applicable functions in hardware. Alternatively, the functions may be performed by at least one other processing unit (or core), on at least one integrated circuit. In other examples, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by at least one general or application-specific processor.

The mobile device 115-c includes antenna(s) 505, transceiver(s) 510, memory 525, a processor 520, and I/O devices 515, which each may be in communication, directly or indirectly, with each other, for example, via at least one bus 535. The transceiver(s) 510 may be configured to communicate bi-directionally, via the antennas 505 with at least one wired or wireless link, such as any of communication links 125 described above in reference to FIGS. 1, and/or 2. The transceiver(s) 510 may include a modem configured to modulate the packets and provide the modulated packets to the antennas 505 for transmission, and to demodulate packets received from the antennas 505. The transceiver(s) 510 may, in conjunction with the antennas 505, transmit and receive packets. The transceiver(s) 510 may be configured to maintain multiple concurrent communication links using the same or different radio interfaces (e.g., Wi-Fi, cellular, etc.). The mobile device 115-c may include a single antenna 505, or the mobile device 115-c may include multiple antennas 505. The mobile device 115-c may be capable of employing multiple antennas 505 for transmitting and receiving communications in a multiple-input multiple-output (MIMO) communication system.

The memory 525 may include random access memory (RAM) and read-only memory (ROM). The memory 525 may store computer-readable, computer-executable software 530 containing instructions that are configured to, when executed, cause the processor 520 to perform various functions described herein. Alternatively, the software 530 may not be directly executable by the processor 520 but may be configured to cause the computer (e.g., when compiled and executed) to perform functions described herein. The processor 520 may include an intelligent hardware device, e.g., a central processing unit (CPU), a microcontroller, an application specific integrated circuit (ASIC), etc.

According to the architecture of FIG. 5, the mobile device 115-c may further include a motion state information module 310-b, a predictive information generator 315-b, and a handover module 320-a including a service provider determination module 540. By way of example, these components of mobile device 115-c may be in communication with some or all of the other components of the mobile device 115-c via bus 535. Additionally or alternatively, functionality of these modules may be implemented via the transceiver 510, as a computer program product stored in software 530, and/or as at least one controller element of the processor 520. In some embodiments, the motion state information module 310-b, the predictive information generator 315-b, and/or the handover module 320-a including the service provider determination module 540 may be implemented as subroutines in memory 525/software 530, executed by the processor 520. In other cases, these modules may be implemented as sub-modules in the processor 520 itself.

The motion state information module 310-b may gather and/or receive motions state information related to the mobile device 115-c, such as RSSI, beacon loss rate information, and/or sensor information, and may communicate the motion state information to the predictive information generator 315-b. The predictive information generator 315-b may then, based on the received motion stat information, generate predictive information relating to movement of the mobile device 115-c. The predictive information generator 315-b may communicate the predictive information to the handover module 310-a, which may use the predictive information to inform the decision of whether to participate in a handover. The decision to handover may then be communicated to the transceiver(s) 510 and antenna(s) 505 to effectuate the decision of whether to handover to a target network/AP 105.

The handover module 320-a may further include a service provider determination module 540. The service provider determination module 540 may receive information, for example via antenna(s) 505 and/or transceiver(s) 510, indicative of whether a nearby AP 105, such as a target AP 105, is associated with a service provider of the serving network/serving AP 105. In some cases, if a nearby AP 105 is not associated with a service provider of the serving network, which may be a WLAN, it may be beneficial to trigger an early handover to the target network, such as a WWAN or another WLAN. In other cases, for example if a target AP 105 has the same SSID but different BSSID as the serving AP 105, it may be beneficial to delay (e.g., not trigger) handover to the target AP 105. In some embodiments, the service provider determination module 540 may request service provider information via the via antenna(s) 505 and/or transceiver(s) 510.

The service provider information may be used by the handover module 320-a as another input to determining whether to participate in a handover, for example in conjunction with RSSI, beacon loss rate information, and/or sensor information. In this way cost may be reduced while still maintaining quality service for the mobile device 115-c.

The remaining components of mobile device 115-c may further implement the procedures described above for using information relating to a motion state of the mobile device 115-c to generate predictive information to be used for participating in a handover, and for the sake of brevity, will not be repeated here.

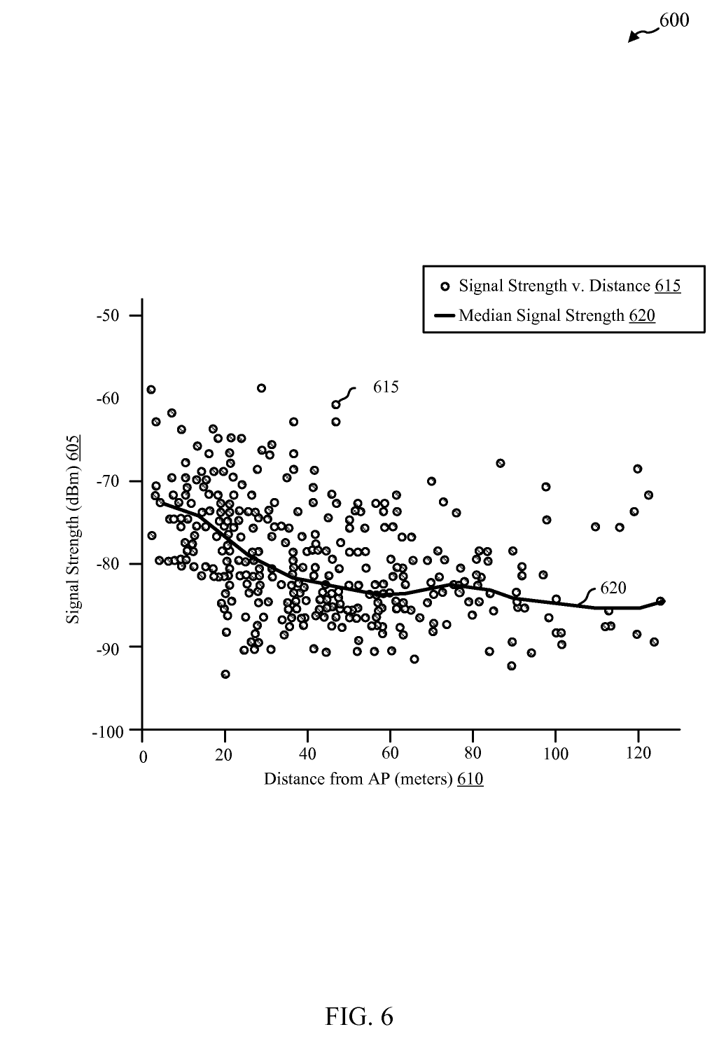

With reference now to FIG. 6, a graph 600 illustrates an exemplary relationship between signal strength measured 605 in dBm on the vertical axis and distance from an AP 610 in meters on the horizontal axis, in accordance with various embodiments. Signal strength 605 values may correspond to RSSI of a mobile device 115 as described in reference to previous Figures. Similarly, distance 610 may correspond to a distance between a mobile device 115 and an AP 105, as also described in reference to previous Figures. The information illustrated by graph 600 may be collected by a mobile device 115 and in some cases communicated to at least one AP 105. The information may be relative to a single AP 105, multiple APs 105 within a certain geographic distance of one another, a network, such as networks 110-114, or any other number of APs where the relationship between signal strength 605 and distance from an AP 105 is relatively consistent.

Graph 600 illustrates various signal strength measurements 615 measured at different indicated distances from an AP 610. Multiple data points from the signal strength measurements 615 may be collected and/or recorded by a mobile device 115. These data points may then be correlated to determine a median signal strength 620, for example for at least one AP 105, by at least one mobile device 115.

As shown in graph 600, the medium signal strength between 0 and 40 meters from an AP is relatively linear, e.g., gradually decreasing from approximately −73 dBm at 0 meters to approximately −82 dBm at 40 meters. As a result, between the distances of 0 to 40 meters, signal strength, and hence RSSI, may be indicative of a distance the mobile device 115 is from an AP 105. Furthermore, when multiple RSSI values are measured in a certain time frame, the change in RSSI values may indicate a speed and direction (e.g., moving toward or away form a serving AP 105) of a mobile device 115 relative to an AP 105. As a result, RSSI may be used to predict movement information of a mobile device 115. For example, the signal strength 605 measured by the mobile device 115 at a first time TO at a certain distance 610, for example within the range of 0 to 40 meters, may be compared with a second signal strength 605 measured by the mobile device 115 at a second time T1. Based on the comparison, it may be possible to predict that the mobile device 115 is moving away from an AP 105. Based on the information illustrated in graph 600, at least one threshold may be determined to improve the accuracy of movement prediction based on signal strength and/or RSSI. For example, in one aspect, RSSI may be a good predictor for movement of the mobile device 115 when the mobile device 115 is determined to be within approximately 40 meters of an AP 105. In other cases, other values and thresholds may be used to a similar affect.

It should be appreciated that graph 600 represents only one sample of data for a given communication environment and for given devices 105, 115. Changes in the communication path, mobile device 115, etc., may change, for example, the signal strength 605 values relative to distance from an AP 610. Accordingly, information represented by graph 600 may be collected by any mobile device 115 to determine a localized relationship between signal strength 605 and distance 610. In this way, signal strength/RSSI may be used by a mobile device 115 to predict whether the mobile device 115 is traveling away from serving network.

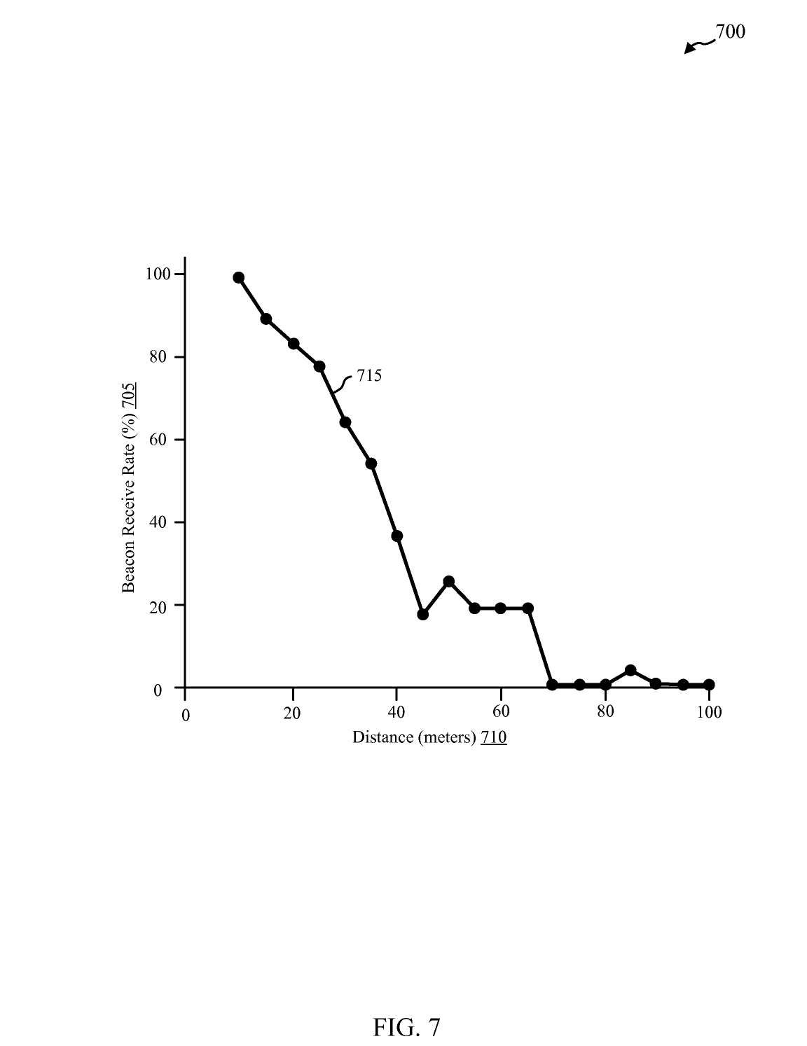

With reference to FIG. 7, graph 700 illustrates an exemplary relationship between beacon receive rate (percentage) values 705 on the vertical axis and distance from an AP 710 in meters on the horizontal axis, in accordance with various embodiments. Beacon receive rate values 705 may inversely correspond to beacon loss rate of a mobile device 115 described in reference to previous Figures. Similarly, distance 710 may correspond to a distance between a mobile device 115 and an AP 105, as also described in reference to previous Figures. The information illustrated by graph 700 may be collected by a mobile device 115 and in some cases communicated to at least one AP 105. The information may be relative to a single AP 105, multiple APs 105 within a certain geographic distance of one another, a network, such as networks 110-114, or any other number of APs where the relationship between beacon receive rate values 705 and distance 710 from an AP 105 is relatively consistent.

Graph 700 illustrates various beacon receive rate percentages measured at different indicated distances 710 from an AP. Multiple data points may be collected and/or recorded by a mobile device 115. These data points may then be correlated to determine a median or average beacon receive rate 715, for example for at least one AP 105, by at least one mobile device 115.

As shown in graph 700, the average beacon receive rate between approximately 10 and 70 meters from an AP is relatively linear, e.g., gradually decreasing from approximately −100% at 10 meters to approximately 0% at 70 meters. As a result, between the distances of 10 to 70 meters, beacon receive rate, and hence beacon loss rate (inversely proportional) may be indicative of a distance the mobile device 115 is from an AP 105. Furthermore, when multiple beacon receive rate values are measured in a certain time frame, the change in beacon receive rate values 705 may indicate a speed and direction (e.g., moving toward or away form a serving AP 105) of the mobile device 115 relative to an AP 105. As a result, beacon receive rate values 705 may be used to predict movement information of a mobile device 115.

In one example, the beacon receive rate values 705 measured by the mobile device 115 at a first time T0 at a certain distance 710, for example within the range of 10 to 70 meters, may be compared with a second beacon receive rate values 705 measured by the mobile device 115 at a second time T1. Based on the comparison, it may be possible to predict that the mobile device 115 is moving away from an AP 105. Based on the information illustrated in graph 700, at least one threshold may be determined to improve the accuracy of movement prediction based on beacon receive rate/beacon loss rate. For example, in one aspect, beacon receive/loss rate may be a good predictor for movement of the mobile device 115 when the mobile device 115 is determined to be within approximately 10 to 70 meters of an AP 105. In other cases, other values and thresholds may be used to a similar affect.

Graph 700 represents only one example of data for a given communication environment and for given devices 105, 115. Changes in the communication path, mobile device 115, etc., may change, for example, the beacon receive rate values 705 relative to distance 710 from an AP. Accordingly, information represented by graph 700 may be collected by any mobile device 115 to determine a localized relationship between beacon receive/loss rate values 705 and distance 710. In this way, beacon receive/loss rate values 705 may be used by a mobile device 115 to predict whether the mobile device 115 is traveling away from serving network.

With reference now to FIG. 8, a graph 800 illustrates an exemplary relationship between RSSI (dBm) values 805 on the vertical axis and time in 100 ms intervals 810 on the horizontal axis, in accordance with various embodiments. RSSI values 805 values may correspond to RSSI of a mobile device 115 as described in reference to previous Figures. In particular, graph 800 illustrates raw measured RSSI values 815, smoothed RSSI values 820, and a first order prediction 825 of RSSI values 805 using a linear regression relative to time intervals 810.

In the example illustrated in graph 800, raw RSSI values 815 from the interval of 4000 to approximately 6500 ms fluctuates from approximately −53 dBm to −44 dBm, while the smoothed RSSI values 820 maintains a relatively consistent value around −52 dBm. The RSSI values 815, 820 in this time period may indicate that the mobile device 115 is either not moving, or not moving away from a serving AP 105. In the time period 830, ranging from approximately 6800 to 11000 ms, however, the RSSI 815, 820 gradually increases from approximately −55 dBm to approximately −44 dBm. Based on this trend in time period 830, a first order prediction 825 of the RSSI may indicate that the RSSI will continue to increase, for example, such as if the mobile device is moving toward an AP 105, to one of the values represented by the circles on line 835. In this scenario, the first order prediction, e.g., statistics, of RSSI may indicate that the mobile device 115 is moving towards a serving AP 105. In this case, the predictive information may be used by the handover module 320 of FIGS. 3 and/or 5 to delay a handover to a target AP 105.

It should be appreciated that beacon receive/loss rate may also be predicted in a similar fashion, using similar techniques. Furthermore, it should also be appreciated that alternatively or additionally, other predictive models of RSSI and/or beacon loss rate may be implemented to generate predictive information of a mobile device 115. For example, non-linear regression and other prediction techniques may be used, as known by those of skill in the art, to improve the accuracy of movement prediction of a mobile device 115.

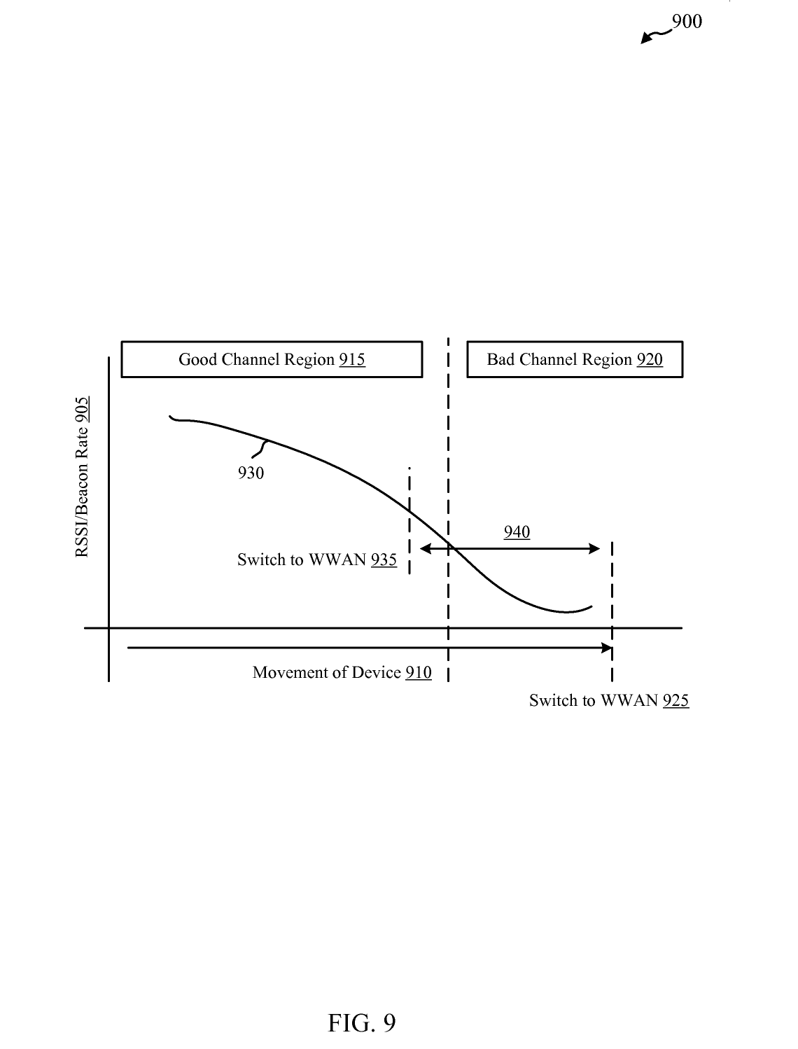

With reference now to FIG. 9, a graph 900 illustrates an exemplary relationship between RSSI/beacon rate 905 on the vertical axis and channel condition regions 915 and 920 on the horizontal axis, in accordance with various embodiments. A first channel condition region 915 may represent a good channel condition region, for example, when the mobile device 115 is within a certain distance of an AP 105. A second channel condition region 920 may represent a bad channel condition region, for example, when the mobile device 115 is near the periphery of a coverage area of a serving AP 105. Graph 900 may represent movement 910 of a mobile device 115 as it moves through and away from the coverage area, such as coverage area 110-a, of a serving network, as described above in reference to FIG. 2.

In particular, as the mobile device 115 moves 910 through the good channel condition region 915 to the bad channel condition region 920, the RSSI/beacon rate 905 may gradually decline along line 930. In accordance with normal handover operation, the mobile device 115 may wait until the RSSI/beacon rate 905 degrades significantly, such that the mobile device is well within the bad channel condition region 920 when it participates in a handover 925, for example with a WWAN.

In contrast, by utilizing the techniques described herein, the mobile device 115 may participate in a handover 935 to a WWAN while still operating within the good channel condition region 915, e.g., a time period 940 before the standard handover 925 would occur. In this way, communication performance, as represented by RSSI/beacon rate 905 may be maintained at a higher level to improve the quality of experience of the end user when the mobile device 115 moves between multiple networks.

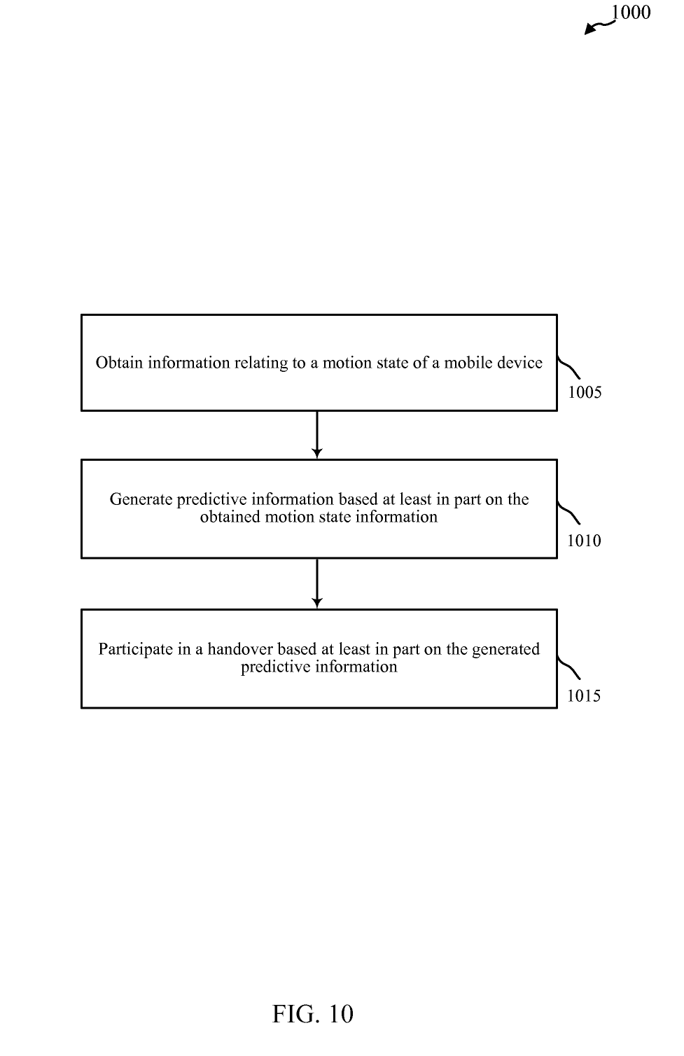

FIG. 10 is a flow chart illustrating one example of a method 1000 for using information relating to a motion state of a mobile device 115 to generate predictive information to be used for participating in a handover, in accordance with various embodiments described herein. For clarity, the method 1000 is described below with reference to at least one aspect of one of the mobile devices 115 described with reference to FIGS. 1, 2, 3, and/or 5. In some embodiments, a device, such as one of the mobile devices 115, may execute at least one set of codes to control the functional elements of the device to perform the functions described below.

At block 1005, a mobile device 115 may obtain information relating to a motion state of the mobile device 115. The operation(s) at block 1005 may in some cases be performed using the motion state information module 310 described with reference to FIGS. 3, 4, and/or 5.

At block 1010, predictive information may be generated based at least in part on the obtained motion state information. The operation(s) at block 1010 may in some cases be performed using the predictive information generator 315 and/or the motion state information module 310 described with reference to FIGS. 3, 4, and/or 5.

At block 1015, the mobile device 115 may participate in a handover based at least in part on the generated predictive information. The operation(s) at block 1015 may in some cases be performed using the handover module 320 and/or the predictive information generator 315 described with reference to FIGS. 3, 4, and/or 5.

Thus, the method 1000 may provide for using motion state information to generate predictive information of a mobile device 115. It should be noted that the method 1000 is just one implementation and that the operations of the method 1000 may be rearranged or otherwise modified such that other implementations are possible.

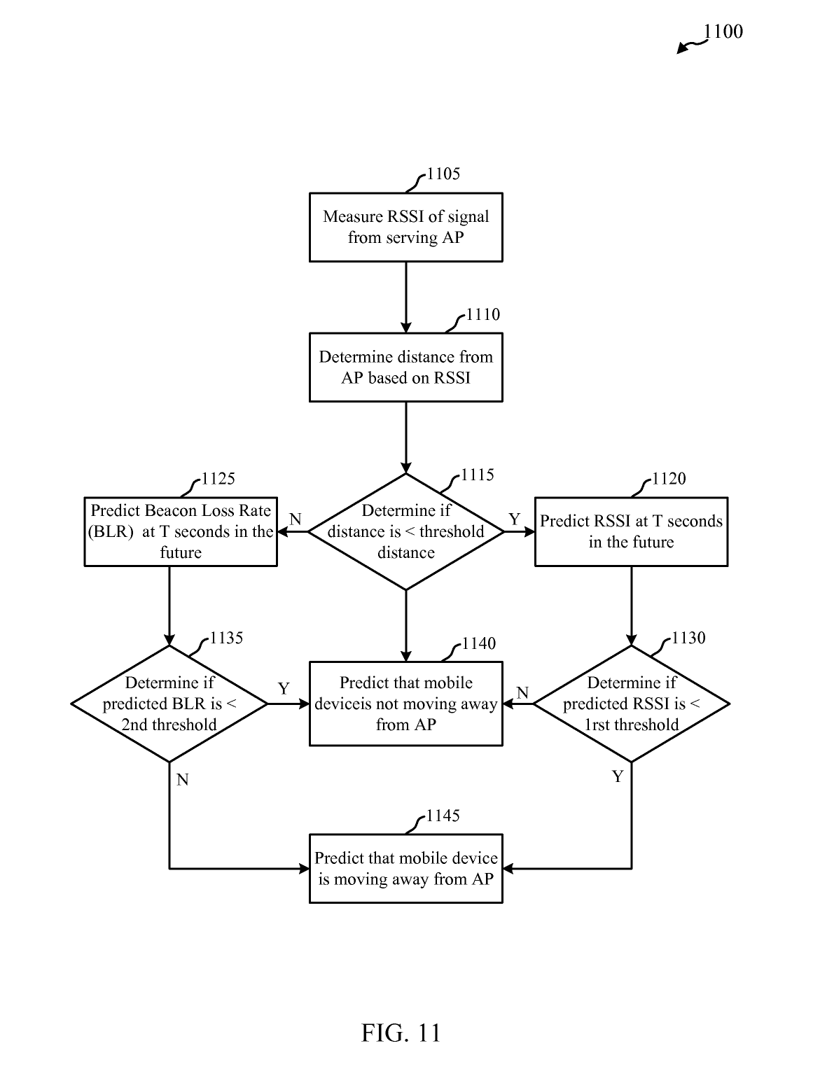

FIG. 11 is a flow chart illustrating one example of a method 1100 for using information relating to a motion state of a mobile device 115 to generate predictive information to be used for participating in a handover, in accordance with various embodiments described herein. For clarity, the method 1100 is described below with reference to at least one aspect of one of the mobile devices 115 described with reference to FIGS. 1, 2, 3, and/or 5. In some embodiments, a device, such as one of the mobile devices 115, may execute at least one set of codes to control the functional elements of the device to perform the functions described below.

At block 1105, the mobile device 115 may measure RSSI of a signal received from a serving AP 105, for example by using the motion state information module 310 described in reference to FIGS. 3, 4, and/or 5, and/or the RSSI module 405 of FIG. 4.

At block 1110, the mobile device 115 may determine a distance from the serving AP 10 based on the RSSI. The distance may be determined by, for example, the RSSI module 405 of FIG. 4. Next, at block 1115, the mobile device 115 may determine if the distance is less than a threshold distance, for example using the predictive information generator 315 of FIGS. 3, 4, and/or 5 and/or the motion state information application module 430 of FIG. 4. In one example, the threshold distance may include any distance between 10 and 40 meters, and may be determined, for example, by the predictive information generator of FIGS. 3, 4, and/or 5, and/or the threshold determination module 425 of FIG. 4. In this scenario, if the distance is less than 10 meters, the mobile device 115 may predict an RSSI value at T seconds in the future at block 1120. If the distance is not less than the threshold distance, for example greater than 10 meters, the mobile device 115 may predict a beacon loss rate (BLR) at T seconds in the future at block 1125.

In other embodiments, more than one threshold may be used at block 1115. For example two threshold distances may be used, for example 10 meters and 40 meters. If the measured distance is greater than 10 meters, the method 1100 may proceed to block 1125, and/or if the distance is less than 40 meters, the method 1100 may additionally or alternatively proceed to block 1120.

In one embodiment, after predicting the RSSI at T seconds in the future at block 1120, the mobile device 115 may determine if the predicted RSSI is less than a first threshold at block 1130. If the answer to that inquiry is no, then method 1100 may proceed to block 1140, where the mobile device 115 may predict that the mobile device is not moving away from the AP 105. In this scenario, handover operations may be delayed (e.g., not triggered early). However, if the predicted RSSI is determined to be less than a first threshold at block 1130, the mobile device 115 may then predict that the mobile device 115 is moving away from the AP 105, and may subsequently communicate this predictive information to inform a decision to not participate in a handover.

Additionally or alternatively, after predicting a BLR at T seconds in the future at block 1125, the mobile device may determine if the predicted BLR is less than a second threshold at block 1135. If the answer to that inquiry is yes, then method 1100 may proceed to block 1140, where the mobile device 115 may predict that the mobile device is not moving away from the AP 105. In this scenario, handover operations may be delayed (e.g., not triggered early). However, if the predicted BLR is determined to be equal to or greater than the second threshold at block 1135, the mobile device 115 may then predict that the mobile device 115 is moving away from the AP 105, and may subsequently communicate this predictive information to inform a decision to not participate in a handover. Operations at blocks 1120, 1125, 1130, 1135, 1140, and/or 1145 may be performed using the predictive information generator 315 of FIGS. 3, 4, and/or 5.

As described above, both operations at blocks 1130 and 1135 may be performed by the mobile device 115 when applicable to increase the accuracy or confidence level of the predictive information.

Thus, the method 1100 may provide for using motion state information to generate predictive information of a mobile device 115. It should be noted that the method 1000 is just one implementation and that the operations of the method 1100 may be rearranged or otherwise modified such that other implementations are possible.

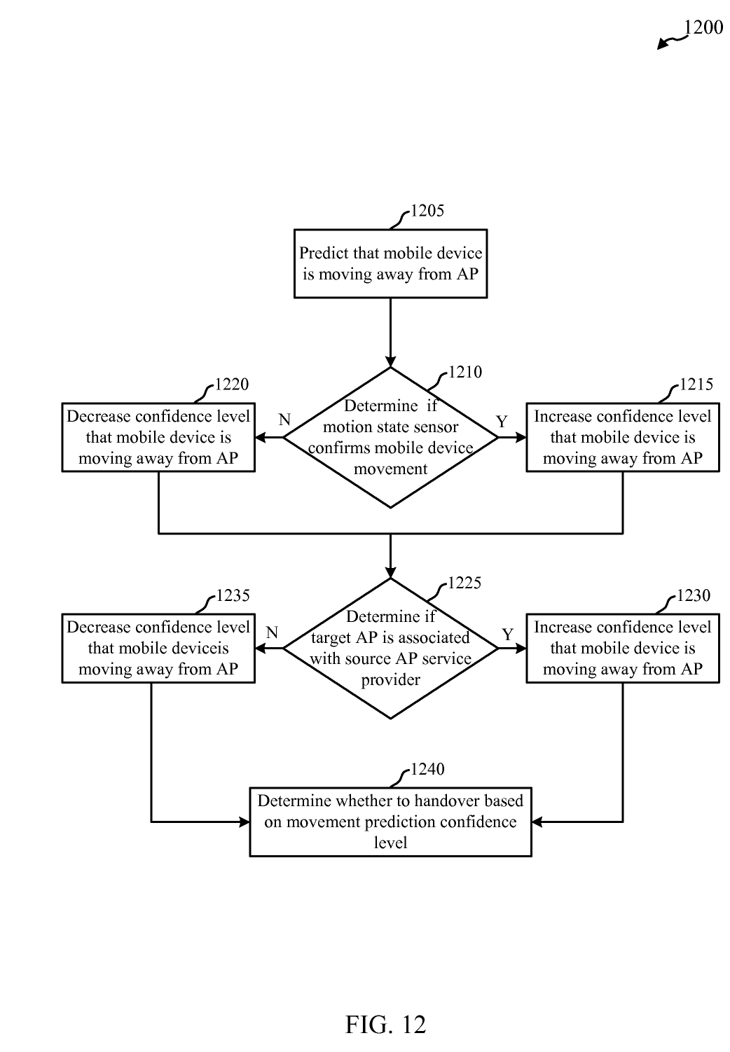

FIG. 12 is a flow chart illustrating one example of a method 1200 for using additional information relating to a motion state of a mobile device 115 and/or service provider information to generate predictive information to be used for participating in a handover, in accordance with various embodiments described herein. For clarity, the method 1200 is described below with reference to at least one aspect of one of the mobile devices 115 described with reference to FIGS. 1, 2, 3, and/or 5. In some embodiments, a device, such as one of the mobile devices 115, may execute at least one set of codes to control the functional elements of the device to perform the functions described below.

The method 1200 may begin where method 1100 ended, such as by the mobile device 115 predicting that the mobile device is moving away from a serving AP 105 at block 1205. The operations at block 1205 may be performed by the predictive information generator 315 of FIGS. 3, 4, and/or 5.

Method 1200 may then proceed to block 1210, where the mobile device 115 may determine if motion state sensor, for example the motion state sensor module 415 of FIG. 4, confirms that the mobile device is currently moving. If the answer to that inquiry is yes, the mobile device 115 may then increase the confidence level of the predicted movement away from the serving AP 105 at block 1215. However, if the answer to that inquiry is no, the mobile device 115 may then decrease the confidence level of the predicted movement away from the serving AP 105 at block 1220. The operations at block 1215 and/or 1220 may be performed by the predictive information generator 315 of FIGS. 3, 4, and/or 5, and/or by the motion state information application module 430 of FIG. 4.

In some cases (not shown), if the motion state sensor does not confirm that the mobile device is moving, the confidence level of the predicted movement may be set to 0, such that no early handover may be imitated.

In either case, the method 1200 may then proceed to block 1225, where the mobile device may determine if the target AP is associated with a source AP service provider. If the answer to that inquiry is yes, the confidence level of the prediction may be increased at block 1230. However, if the answer to that inquiry is no, the confidence level of the prediction may be decreased at block 1235. In either case, the method 1200 may proceed to block 1240, where the mobile device 115 may determine whether to participate in a handover based on the movement prediction confidence level. The operations at blocks 1225, 1230, 1235, and/or 1240 may be performed using the handover module 320 of FIGS. 3, 4, and/or 5, and/or the service provider determination module 540 of FIG. 5.

Thus, the method 1200 may provide for using additional motion state information and service provider information to generate predictive information of a mobile device 115. It should be noted that the method 1200 is just one implementation and that the operations of the method 1200 may be rearranged or otherwise modified such that other implementations are possible.

Techniques described herein may be used for various wireless communications systems such as an IEEE 802.11 (Wi-Fi, Wi-Fi P2P, Wi-Fi Direct, etc.) system. The techniques described herein may be used for the systems and radio technologies mentioned above as well as other systems and radio technologies. The description above, however, describes a WLAN system for purposes of example, and WLAN terminology is used in much of the description above, although the techniques are applicable beyond WLAN applications.

For example, techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1x, 1x, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. LTE terminology may be used in much of the description above, although the techniques are applicable beyond LTE applications.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks, components, and modules described in connection with the disclosure herein may be implemented or performed with an at least one general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, at least one microprocessor in conjunction with a DSP core, or any other such configuration.

The functions described herein may be implemented in hardware, software executed by a processor, firmware, or any combination thereof. If implemented in software executed by a processor, the functions may be stored on or transmitted over as at least one instruction or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method for wireless communication, comprising:
obtaining, by a mobile device, information relating to a motion state of the mobile device;
generating predictive information based at least in part on the obtained motion state information; and
participating in a handover based at least in part on the generated predictive information.

2. The method of claim 1, wherein the information relating to the motion state of the mobile device indicates that the mobile device is moving away from an access point (AP).

3. The method of claim 2, wherein the information relating to the motion state of the mobile device indicates that the mobile device is moving away from multiple APs of a serving network; and wherein the generating predictive information based at least in part on the obtained motion state information comprises:
predicting whether the mobile device is moving away from each of the multiple APs of the serving network.

4. The method of claim 1, wherein the participating in the handover based at least in part on the generated predictive information comprises participating in the handover prior to at least one of disconnection with a serving network or a connection quality with the serving network falling below a connection quality threshold.

5. The method of claim 1, wherein the obtaining information comprises:
obtaining measurements of at least one of a first metric or a second metric when a first threshold is satisfied.

6. The method of claim 5, wherein the measurements of the first metric comprise received signal strength indicator (RSSI) information and the measurements of the second metric comprise beacon loss rate information.

7. The method of claim 5, wherein the first threshold comprises a RSSI value, the RSSI value correlating to a distance between the mobile device and at least one AP.

8. The method of claim 5, wherein the generating predictive information comprises:
predicting a first value of the first metric at a future time;
predicting a second value of the second metric at the future time; and
predicting that the mobile device is moving away from an AP if the predicted value of the first metric exceeds a first threshold, the predicted value of the second metric exceeds a second threshold, or a combination thereof.

9. The method of claim 1, wherein the obtaining information comprises:
obtaining motion state information of the mobile device from at least one sensor.

10. The method of claim 9, wherein the at least one sensor comprise at least one of an accelerometer or a course motion classifier.

11. The method of claim 9, wherein the obtaining information comprises:
obtaining measurements of at least one of a first metric or a second metric when a threshold is satisfied, wherein the generating predictive information comprises:
predicting that the mobile device is moving away from at least one AP if at least one of the measurements of the first metric or the measurements of the second metric indicate that the mobile device is moving away from the at least one AP, and the motion state information from the at least one sensor indicates that the mobile device is moving away from the at least one AP.

12. The method of claim 1, wherein the generating predictive information comprises:
generating a prediction that the mobile device is moving away from a serving network based at least in part on the obtained information.

13. The method of claim 1, wherein the handover is from a serving network to a target network, the serving network being a first wireless local area network (WLAN) and the target network being a wireless wide area network (WWAN) or a second WLAN.

14. The method of claim 13, wherein the serving network is associated with a first service provider, the method further comprising:
determining whether the target network is associated with the first service provider; and
participating in the handover based at least in part on the determination.

15. A mobile device comprising:
a motion state information module to obtain information relating to a motion state of the mobile device;
a predictive information generator to generate predictive information based at least in part on the obtained motion state information; and
a handover module to participate in a handover based at least in part on the generated predictive information.

16. The mobile device of claim 15, wherein the information relating to the motion state of the mobile device indicates that the mobile device is moving away from at least one of at least one AP or a serving network; and wherein the predictive information generator is configured to predict whether the mobile device is moving away from at least one of the at least one AP or the serving network.

17. The mobile device of claim 15, wherein the handover module is configured to participate in the handover prior to at least one of disconnection with a serving network or a connection quality with the serving network falling below a connection quality threshold.

18. The mobile device of claim 15, wherein the motion state information module is configured to obtain measurements of at least one of a first metric or a second metric when a threshold is satisfied.

19. The mobile device of claim 18, wherein the measurements of the first metric comprise RSSI information and the measurements of the second metric comprise beacon loss rate information.

20. The mobile device of claim 18, wherein the predictive information generator is configured to:
predict a first value of the first metric at a future time;
predict a second value of the second metric at the future time; and
predict that the mobile device is moving away from an AP if the predicted first value of the first metric exceeds a first threshold, the predicted second value of the second metric exceeds a second threshold, or a combination thereof.

21. The mobile device of claim 18, wherein the motion state information module is configured to:
obtain motion state information of the mobile device from at least one sensor; and wherein the predictive information generator is configured to:
predict that the mobile device is moving away from at least one AP if at least one of the measurements of the first metric or the measurements of the second metric indicate that the mobile device is moving away from the at least one AP, and the motion state information from the at least one sensor indicates that the mobile device is moving away from the at least one AP.

22. The mobile device of claim 15, wherein the handover is from a serving network associated with a first service provider to a target network; and wherein the handover module is configured to:
determine whether the target network is associated with the first service provider; and
participate in the handover based at least in part on the determination.

23. An apparatus comprising:
means for obtaining, by a mobile device, information relating to a motion state of the mobile device;
means for generating predictive information based at least in part on the obtained motion state information; and
means for participating in a handover based at least in part on the generated predictive information.

24. The apparatus of claim 23, wherein the information relating to the motion state of the mobile device indicates that the mobile device is moving away from at least one of at least one AP or a serving network; and wherein the means for generating predictive information is configured to predict whether the mobile device is moving away from at least one of the at least one AP or the serving network.

25. The apparatus of claim 23, wherein the means for obtaining motion state information comprises:
means for obtaining measurements of at least one of a first metric or a second metric when a threshold is satisfied.

26. The apparatus of claim 25, wherein the measurements of the first metric comprise RSSI information and the measurements of the second metric comprise beacon loss rate information.

27. The apparatus of claim 25, wherein the means for generating predictive information is configured to:
predict a first value of the first metric at a future time;
predict a second value of the second metric at the future time; and
predict that the mobile device is moving away from an AP if the predicted first value of the first metric exceeds a first threshold, the predicted second value of the second metric exceeds a second threshold, or a combination thereof.

28. The apparatus of claim 25, wherein the means for obtaining motion state information is configured to:
obtain motion state information of the mobile device from at least one sensor; and wherein the means for generating predictive information is configured to:
predict that the mobile device is moving away from at least one AP if at least one of the measurements of the first metric or the measurements of the second metric indicate that the mobile device is moving away from the at least one AP, and the motion state information from the at least one sensor indicates that the mobile device is moving away from the at least one AP.

29. The apparatus of claim 23, wherein the handover is from a serving network associated with a first service provider to a target network; and wherein the means for participating in the handover is configured to:
determine whether the target network is associated with the first service provider; and
participate in the handover based at least in part on the determination.

30. A computer program product operable on a mobile device, the computer program product comprising a non-transitory computer-readable medium storing instructions executable by a processor to:
obtain information relating to a motion state of the mobile device;
generate predictive information based at least in part on the obtained motion state information; and
participate in a handover based at least in part on the generated predictive information.
